(19) United States
(12) Patent Application Publication
(10) Pub. No.: US 2020/0074348 A1
(43) Pub. Date: Mar. 5, 2020

(54) MULTI-FUNCTION IMPROVEMENT FOR MACHINE LEARNING SYSTEMS

(71) Applicant: FUJITSU LIMITED, Kawasaki-shi (JP)

(72) Inventor: Suhas CHELIAN, San Jose, CA (US)

(73) Assignee: FUJITSU LIMITED, Kawasaki-shi (JP)

(21) Appl. No.: 16/118,281

(22) Filed: Aug. 30, 2018

(51) Int. Cl. G06N 99/00; G06N 5/04

(52) U.S. Cl. CPC G06N 99/005; G06N 5/04

(57) ABSTRACT

A method may include identifying multiple evaluation functions related to operation of a machine learning system as a first set of inputs for a computing process configured to generate a Pareto set of solutions of the evaluation functions. The method may also include identifying a set of initial search points for the computing process, each of the search points including a potential solution of the evaluation functions, each of the potential solutions including values for a set of variables affecting the evaluation functions and an associated weight for each of the variables. The method may also include performing the computing process using both the evaluation functions and the set of initial search points such that the computing process varies the potential solutions over a potential solution space, thereby identifying the Pareto set of solutions that improve or hold steady a performance score of each of the evaluation functions.

### FIELD

Embodiments of the disclosure relate to multi-function improvement for machine learning systems.

### BACKGROUND

Machine learning systems may utilize multiple different objectives upon which a desired outcome is based. However, certain variables may affect one objective positively while affecting another objective negatively. The process of accounting for such variations while finding improvements or solutions that take into account the multiple objectives can be difficult and resource intensive.

### SUMMARY

One or more embodiments of the present disclosure may include a method that includes identifying multiple evaluation functions related to operation of a machine learning system as a first set of inputs for a computing process configured to generate a Pareto set of solutions of the evaluation functions, where the evaluation include at least two of generalization performance of the machine learning system, computing resource utilization of the machine learning system, or model interpretability. The method may also include identifying a set of initial search points for the computing process, each of the search points including a potential solution of the evaluation functions, and each of the potential solutions including values for a set of variables affecting the evaluation functions and an associated weight for each of the variables. The method may also include performing the computing process using both the evaluation functions and the set of initial search points such that the computing process varies the potential solutions over a potential solution space, thereby identifying the Pareto set of solutions that improve or hold steady performance scores across one or more of the evaluation functions.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example process of multi-function improvement for machine learning systems;

FIGS. 2A-2C are diagrams illustrating example visualizations of various spaces explored in improving the evaluation functions;

FIG. 3 illustrates a flow diagram of a method of improving evaluation functions for machine learning;

FIG. 4 illustrates a flow diagram of an example computing process method used in improving evaluation functions; and

FIG. 5 illustrates an example computing system.

### DETAILED DESCRIPTION

The present disclosure relates to the use of a computing process to identify a set of solutions to a multi-objective problem, where the set of solutions improves performance of a computing device performing machine learning across multiple objectives. The computing process may utilize an algorithm, such as a second generation adaptive weighted aggregation (AWA-2) algorithm to identify the set of solutions that improves a given evaluation function without potentially negatively impacting other evaluation functions. For example, if the evaluation functions are related to operating a car, such as the evaluation functions of vehicle power and vehicle fuel efficiency, a number of variables such as engine size, vehicle weight, tire size, etc. may be analyzed to find a set of values for the variables that improves one of vehicle power or fuel efficiency without potentially negatively affecting the other. In some embodiments, the evaluation functions may relate to a machine learning system, such as model accuracy, computing resource frugality, and/or model interpretability. In these and other embodiments, performing the computing process may identify how the machine learning model may be operated and/or parameters to be selected to improve functioning of the computing system operating the machine learning model.

One or more example embodiments are explained with reference to the accompanying drawings.

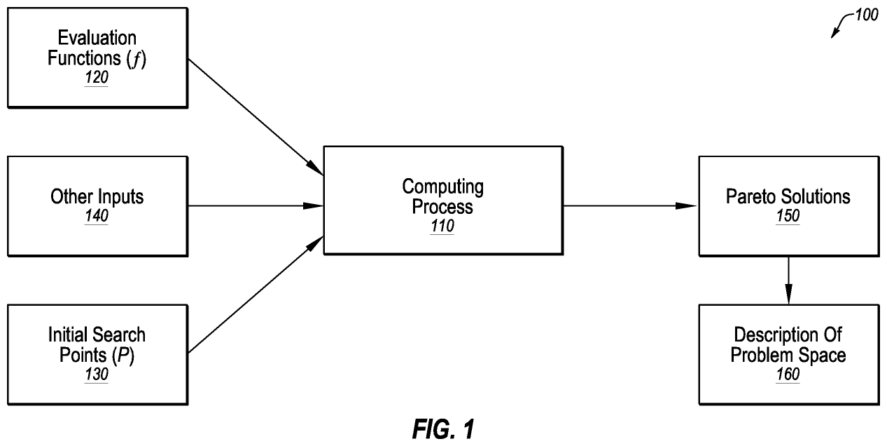

FIG. 1 is a diagram illustrating an example process 100 of multi-function improvement for machine learning systems, in accordance with one or more embodiments of the present disclosure. The process 100 may include a computing process 110 that may receive inputs and may output one or more results to facilitate improvement of a computing system. The computing process 110 may receive as inputs one or more evaluation functions 120 (f) that may operate as the basis upon which the computing process 110 is improved or optimized as described below. Other inputs to the computing process may include one or more initial search points 130 (P representing a set of individual search points, p), and other inputs 140. The computing process 110 may output a set of Pareto solutions 150, which may be used to provide a description of a problem space 160. As used herein, a Pareto solution 150 may refer to a solution with a set of values such that performance relative to an objective function is improved without potentially negatively impacting another objective function. For example, given two sets of variables for two different solutions when considered relative to two evaluation functions, if one set of variables provides a higher performance score for one of the evaluation functions than the other set of variables, and the performance score for the other evaluation function is the same, the set of variables with the higher performance score would be a Pareto solution between the two solutions as the performance scores of the evaluation functions improved or held steady compared to the other solutions.

The computing process 110 may include an algorithm, process, or other analysis that seeks to identify a set of solutions that improves or optimizes a process using the evaluation functions 120 as the basis for improvement. For example, if the evaluation functions 120 were vehicle power and fuel efficiency, the computing process 110 may explore various values for variables that affect one or both of these evaluation functions 120 (e.g., the variables of vehicle size, motor size, vehicle shape, etc.). In some embodiments, the evaluation functions 120 may relate to a common goal. Following the example above, vehicle power and fuel efficiency relate to the goal of operating a vehicle.

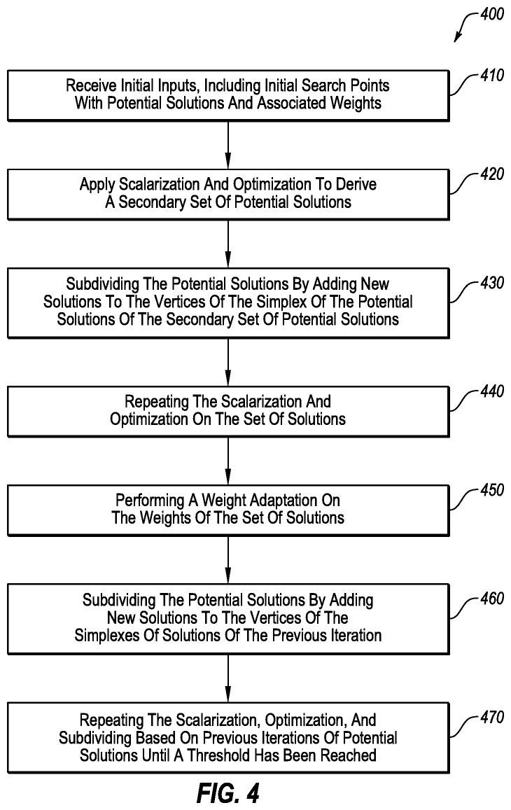

In some embodiments, the computing process 110 may include a multi-objective optimization algorithm, such as the adaptive weighted aggregation (AWA) algorithm or the AWA-2 algorithm. In these and other embodiments, the multi-objectives referred to may include the evaluation functions 120. For example, as described above, the evaluation functions 120 may include the bases upon which the computing process 110 is improved and/or optimized. The AWA-2 algorithm may operate to aggregate a given multi-objective optimization problem into a single-objective function optimization problem using a user-specified scalarization method. The AWA-2 algorithm may search solutions for the single-objective problem by a user-specified single-objective optimization approach, yielding a Pareto set of solutions of the multi-objective optimization problem. The AWA-2 algorithm may start with an initial set of search points as an initial potential set of solutions, and may iteratively apply the scalarization, optimization, and a subdivision and weight adaptation to derive the Pareto set of solutions. Such a process may be described in greater detail with respect to FIG. 4. As used herein the term optimize or optimization does not necessarily refer to finding the absolute optimal condition, rather, the term includes a much broader concept including improvement, however small, and something may be optimized even if further improvement may be possible when the optimization has ceased.

The evaluation functions 120 may include any function, feature, or factor upon which the computing process 110 is measured. The evaluation functions 120 may yield performance values based on the different values of the variables included in potential solutions. For example, if a given evaluation function were vehicle power, a performance value of vehicle power may represent the vehicle power based on the variables of engine size, vehicle weight, vehicle shape, type and size of tires, etc. The performance value may be used to derive a performance score. In some embodiments, the performance score may be a normalized value between zero and one such that various evaluation functions may be directly compared. For example, if vehicle power performance value is a numerical value of torque, the performance score may be torque divided by some number higher than all vehicles (e.g., 1,500 lbf·ft of torque). Following the numerical example, if a vehicle's power for a set of variables of a solution was 300 lbf·ft of torque, the performance value is 300 and the performance score is 300/1,500=0.2.

In some embodiments, the evaluation functions 120 may relate to improving the performance of a computer system and/or a machine learning system based on one or more objectives. For example, such evaluation functions may include model accuracy or generalization performance of a machine learning model being used, resource frugality of computing resources being used, model interpretability of the machine learning model, etc. In the examples below, an evaluation function refers to an objective, while a score refers to how to convert an algorithm observable (e.g., compute time) into a numerical output for the evaluation function. If one of the evaluation functions includes model accuracy or generalization performance, the evaluation function may utilize a performance value of number correct or number incorrect as generated by a classification or regression machine learning system, etc. The performance score may include a value such as percentage correct, one minus the mean absolute error (MAE), etc. If one of the evaluation functions includes resource frugality, the performance value may include runtime, memory use, power use, number of nodes in a regression tree, number of layers in a deep learning network, etc. or any other metrics related to computing resource utilization. The performance score may include a value such as the inverse of such values (e.g., 1/runtime, 1/memory use, 1/power use, etc.). If one of the evaluation functions includes model interpretability, the performance value may include values of a Likert scale or other rating model, and the performance value may include the Likert scale value of interpretability, with the performance score including a normalized value (e.g., if the values of the Likert scale are a number between one and five, the average divided by five). Additionally or alternatively, if a known factor negatively affects the interpretability, the inverse may be used. For example, for the number of nodes in a classification and regression tree machine learning model, the performance score and performance value may be the inverse of the number of nodes. As another example, for a deep learning network, the performance score and value may be the inverse of the number of layers. Any number (m) of evaluation functions 120 are contemplated by the present disclosure. While various examples include two or three evaluation functions 120, there may be more. In these and other embodiments, if the number of evaluation functions 120 exceeds three, a graphical visualization of the evaluation functions may or may not be provided.

The initial search points 130 may include a set of initial values for the computing process 110 to utilize in measuring the evaluation functions 120. A given search point may have a set of variables (X) with individual variables (x₁, x₂, x₃, . . . ). Additionally or alternatively, each individual variable may be given a corresponding weight value, such as between zero and one. For example, if the evaluation functions included vehicle power and fuel efficiency, the set of initial values of the initial search points may include an initial search point (p₁) with x₁=four cylinder engine, x₂=three thousand pounds total vehicle weight, x₃=sedan-shaped, etc., with weights w₁=(1, 0, 0) in a weight vector with each value corresponding to a respective variable and another initial search point (p₂) with x₁=four cylinder engine, x₂=four thousand pounds of total vehicle weight, x₃=sedan-shaped, etc., with weights w₂=(0, 1, 0). While two initial search points are provided in the above example, any number of initial search points may be provided. In these and other embodiments, even the initial search points may be considered as potential solutions.

With respect to machine learning improvement, such as a classification and regression trees (CART) machine learning system, a set of variables (X) may include maximum tree depth, minimum leaf size, and minimum impurity split, and the initial set of search points may include p₁: x₁=max. tree depth=1, min. leaf size=1, min. impurity split=0, w1=(1,0, 0); p₂: x₂=max. tree depth=2, min. leaf size=10, min. impurity split=1e-7, w2=(0, 1, 0); and p₃: x₃=max. tree depth=10, min. leaf size=2, min. impurity split=1e-2, w3=(0, 0, 1). As another example, a set of variables for deep learning may include x₁ for number of layer 1, x₂ for the L2 weight regularization term, and x₃ for dropout rate. As another example, consider performing machine learning with CART or deep learning models. In such an example, the first dimension of x can be 0 (or 1) for CART (or deep learning) models and the additional dimensions of x can be parameters specific to each algorithm. In these and other examples, search points which chose the CART (or the deep learning) algorithm with deep learning (or CART) parameters may be instantly rejected as not viable search points as the parameters may be inconsistent or incompatible with the algorithm.

In some embodiments, depending on the algorithm or process used as the computing process 110, various other inputs 140 may be provided to the computing process 110. For example, for an AWA-2 algorithm, the other inputs 140 may include a scalarization method (s), a single-objective optimization method (o), a coordinate function (φ), a learning rate (γ), a tolerance (ε), and a search point size (μ). The scalarization method (s) may include the type of scalarization method used when converting the multi-objective problem into a single-objective problem, such as a weighted Chebyshev norm method, an L^{P} norm method, or any other scalarization method. The single-objective optimization method (o) may include the type of single-objective optimization used on the scalarized multi-objective problem, such as steepest descent, a genetic algorithm, particle swarm optimization (PSO), the fireworks algorithm, or any other optimization approach. The coordinate function (φ) may include one of a number of options, such as “variable,” which improves coverage on the Pareto set of solutions using the coordinate function of the variable space of the potential solutions; “objective,” which improves coverage on the Pareto front using the coordinate function of the space of the evaluation functions; and “without adaptation,” which may not improve coverage on any space, instead using a zero function. The third option (“without adaptation”) may function in a similar manner to a multi-starting descent approach using scalarization with evenly distributed weight vectors. The learning rate (γ) may represent the rate at which the weight vectors may be varied. The tolerance (ε) may represent the tolerance within which values are considered the same. The search point size (μ) may include a limit to the search point size and may be based on the number (m) of evaluation functions 120.

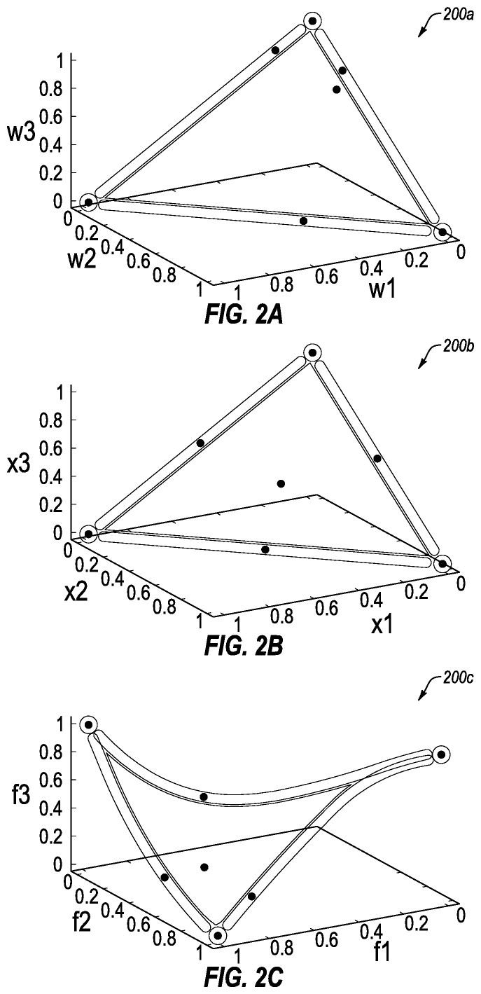

The Pareto solutions 150 output by the computing process 110 may represent a set of values for variables, or a series of sets of values for variables that represent the values for which each evaluation function is improved while the other evaluation functions have potentially remained the same or improved. In some embodiments, multiple Pareto solutions 150 are observed along a front. For example, given three evaluation functions, there may be a Pareto solution for a series of performance scores as the values of one of the Pareto solutions is varied, yielding a series of Pareto solutions. FIG. 2C illustrates an example of a Pareto front for a three-evaluation-function scenario.

In some embodiments, a description of the problem space 160 may be output based on the Pareto solutions 150. For example, the computing process 110 may generate a visualization of the Pareto solutions 150 for understanding the problem space. As another example, the computing process 110 may output a textual or numerical description of the results of the solutions. For example, if a given combination of values of the search points consistently score high (e.g., a threshold density of potential solutions) for multiple evaluation functions while one or two evaluation functions scored low, the computing process 110 may output an indication of which evaluation functions were high and which were low. In these and other embodiments, the computing process 110 may output an indication that the low valued evaluation functions may be an area in which future development or emphasis may be placed, whether in further optimization analysis or in other efforts at improvement.

In some embodiments, the operation of the computing process 110 may cause a computing system to operate in a more efficient manner. For example, if the evaluation functions 120 relate to operation of a machine learning process on a computing system, the computing process 110 may yield parameters within which the computing system operates more efficiently and/or more accurately by improving certain evaluation functions 120 without potentially harming the performance of other evaluation functions 120. In some embodiments, operation of a computing system that is operating a machine learning system may be modified based on the outputs of the computing process 110. In these and other embodiments, such an approach provides a technological improvement to the field of machine learning and allows the computing system to operate more efficiently and/or effectively.

In some embodiments, one or more of the various inputs (e.g., the evaluation functions 120, the initial search points 130, and/or the other inputs 140) may be received by a computing system from a user. In some embodiments, a secondary computing system may be utilized to analyze and/or otherwise perform the computing process 110 relative to a primary computing system operating a machine learning system. In these and other embodiments, the primary and secondary computing systems may be in communication. In some embodiments, the secondary computing system performing the computing process 110 maybe configured to adjust the operation of the primary computing system based on the computing process 110.

Modifications, additions, or omissions may be made to FIG. 1. For example, any number of inputs and/or outputs may be included with the computing process 110. As another example, the computing process may be performed multiple times and/or iteratively to ultimately yield the outputs.

FIGS. 2A, 2B, and 2C are diagrams illustrating example visualizations 200a, 200b, and 200c (respectively), of various spaces explored in improving the evaluation functions, in accordance with one or more embodiments of the present disclosure. FIG. 2A illustrates a corresponding example of the weight distribution of the various weights, w₁, w₂, and w₃, corresponding to the variables x₁, x₂, and x₃, respectively. FIG. 2B illustrates an example of Pareto solutions of values of three variables, x₁, x₂, and x₃ and the exploration that occurred in the solution space of adjusting the variables. FIG. 2C illustrates a corresponding example of the values of the evaluation function performance scores for the various solutions that are output. For all three figures, the dots represent the obtained output solutions. The surface in FIG. 2A illustrates the potential weight space explored, the surface in FIG. 2B illustrates the potential Pareto set of solutions in terms of variables, and the surface in FIG. 2C illustrates the Pareto front of solutions in terms of the objective functions.

For convenience in describing FIGS. 2A-2C, the example above regarding machine learning in a CART system will be utilized, where x₁, x₂, and x₃ correspond to maximum tree depth, minimum leaf size, and minimum impurity split, respectively; weights w₁, w₂, and w₃ correspond to the variables x₁, x₂, and x₃, respectively; and f₁, f₂, and f₃ correspond to model accuracy, resource frugality, and model interpretability, respectively. Additionally or alternatively, in the case of deep learning, x₁, x₂, and x₃ may correspond to number of layers, L2 weight regularization term and dropout rate in that order, etc.

As illustrated in FIG. 2A, the majority of points have low values for maximum tree depth, minimum leaf size, and a high value for minimum impurity split. As illustrated in FIG. 2B, the points in the variable space are reasonably evenly distributed showing good coverage on the Pareto set of solutions. As illustrated in FIG. 2C, the majority of points have high f₁ and f₂ scores and low f₃ scores.

In some embodiments, the computing system performing the computing process may analyze the visual representations of the results, for example, to detect regions of point density above a threshold. Based on the analysis, a description of the problem space may be provided. Continuing the example of FIGS. 2A-2C, the description may indicate that most solutions have small tree depths, leaves with a small number of points in them, and a large amount of split impurity (from FIG. 2A), and most solutions are accurate and frugal with respect to resource utilization but with low model interpretability (from FIG. 2C). In some embodiments, based on such an analysis, a recommendation for future efforts or work may be provided. For example, an indication may be provided that a recommendation for future work may include improving model interpretability. Additionally or alternatively, in the case of deep learning, results may have a small amount of layers, low L2 weight regularization and a high dropout rate, etc.

Modifications, additions, or omissions may be made to the FIGS. 2A-2C without departing from the scope of the present disclosure. For example, depending on the number of evaluation functions, the number of variables (x) considered, etc., the shape of the visualizations 200a, 200b, and 200c may vary. As another example, depending on the number of iterations through which the computing process proceeds, the number and distribution of points may vary.

In some embodiments, if the number of evaluation functions exceeds three, a textual or tabular output of the results of the computing process may be provided rather than the visual output depicted in FIGS. 2A-2C.

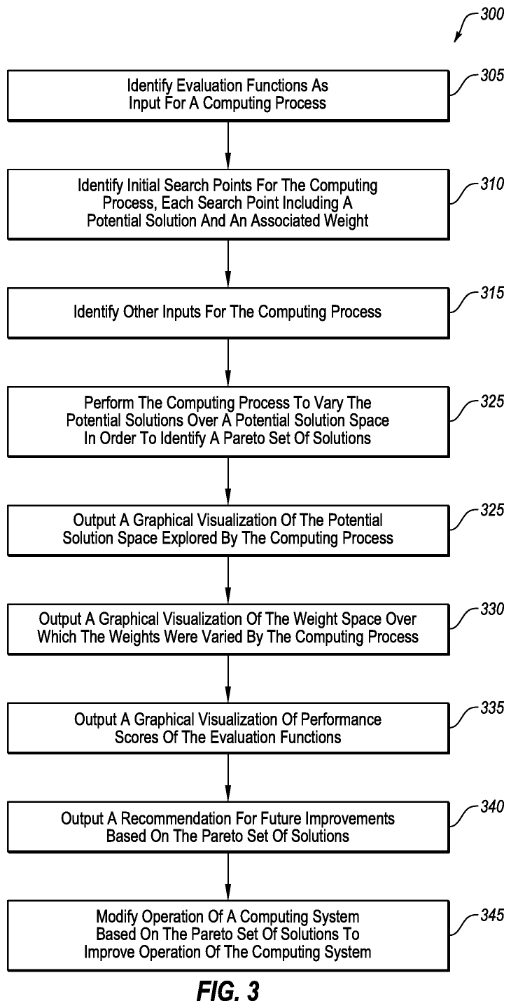

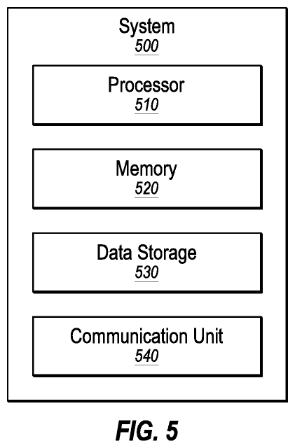

FIG. 3 illustrates a flow diagram of a method 300 of improving evaluation functions for machine learning, in accordance with one or more embodiments of the present disclosure. One or more operations of the method 300 may be performed by a system or device, or combinations thereof, such as the primary or secondary computing systems described with respect to FIG. 1 and/or the computing system of FIG. 5. For illustrative purposes, various blocks below will be identified as potentially being performed by one of a primary computing system and a secondary computing system as described with reference to FIG. 1. In these and other embodiments, the method 300 may be performed based on the execution of instructions stored on one or more non-transitory computer-readable media. Although illustrated as discrete blocks, various blocks of the method 300 may be divided into additional blocks, combined into fewer blocks, or eliminated, depending on the desired implementation.

At block 305, one or more evaluation functions may be identified as inputs for a computing process. For example, a user may input one or more evaluation functions at a secondary computing system related to operation of a machine learning system on a primary computing system, or other operation of the primary computing system. In some embodiments, the evaluation functions may relate to a common goal, such as the operation of a vehicle, the operation of a computing system, etc. In some embodiments, the evaluation functions may relate to the operation of a machine learning system, including one or more of computer resource frugality, model accuracy, and interpretability of a machine learning model.

At block 310, initial search points may be identified for the computing process. For example, a user may input the initial search points. As another example, the secondary computing system may select initial search points at random or based on some other automated selection process. In some embodiments, each search point may include a potential solution (e.g., a set of values for the variables) and an associated weight vector with a weight for each of the variables.

At block 315, other inputs may be identified for the computing process. For example, a series of values, functions, variables, etc. may be provided by a user to the secondary computing system or be preselected by the secondary computing system. Such other inputs may include values utilized by various algorithms that may be utilized for the computing process. For example, for an AWA-2 algorithm, the other inputs may include a scalarization method (s), a single-objective optimization method (o), a coordinate function (φ), a learning rate (γ), a tolerance (ε), and a search point size (μ).

At block 320, the computing process may be performed to vary the potential solutions over a potential solution space in order to identify a Pareto set of solutions. For example, the computing process may iteratively apply scalarization, optimization, and a subdivision and weight adaptation to the initial search to points derive the Pareto set of solutions. A more detailed description of the computing process may be described with reference to FIG. 4.

At block 325, a graphical visualization of the potential solution space explored by the computing process may be outputted. For example, the secondary computing device may display a graphical visualization similar or comparable to that illustrated in FIG. 2B. In some embodiments, the graphical visualization may display the subset of the solution space representing the Pareto solutions. In some embodiments, the visualization may include both a surface representing the Pareto solutions as well as specific points output by the computing process of block 320.

At block 330, a graphical visualization of the weight space over which the weights were varied during the computing process may be outputted. For example, the secondary computing device may display a graphical visualization similar or comparable to that illustrated in FIG. 2A.

At block 335, a graphical visualization of the performance scores of the evaluation functions may be outputted. For example, the secondary computing device may display a graphical visualization similar or comparable to that illustrated in FIG. 2C.

At block 340, a recommendation for future improvements based on the Pareto set of solutions may be outputted. For example, the secondary computing device may analyze one or more of the graphical visualizations of the blocks 325, 330, and/or 335. As another example, the secondary computing device may analyze a textual or numerical description of the Pareto set of solutions. Based on the analysis, the secondary computing device may recommend one or more areas in which future improvements may be based. In some embodiments, such recommendations may include one or more of the evaluation functions. For example, if the evaluation functions included model accuracy, resource frugality, and model interpretability, a recommendation may be to focus improvements on model interpretability.

At block 345, operation of a computing system may be modified based on the Pareto set of solutions to improve operation of the computing system. For example, the secondary computing system may provide an instruction to the primary computing system to modify the manner in which it is operating a machine learning system to utilize values for parameters as provided in one or more of the Pareto solutions identified in the computing process of block 320.

One skilled in the art, after reviewing this disclosure, may recognize that modifications, additions, or omissions may be made to the method 300 without departing from the scope of the disclosure. For example, the operations of the method 300 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 4 illustrates a flow diagram of a method 400 of improving evaluation functions for machine learning, in accordance with one or more embodiments of the present disclosure. The method 400 may be example operations associated with the computing process associated with the computing process 110 of FIG. 1 and/or the block 320 of FIG. 3. For example, in some embodiments, the operations of the method 400 may perform an AWA-2 algorithm using evaluation functions as the multiple objectives. One or more operations of the method 400 may be performed by a system or device, or combinations thereof, such as the computing systems described with respect to FIGS. 1 and/or 5. For illustrative purposes, various blocks below will be identified as potentially being performed by one of a primary computing system and a secondary computing system as described with reference to FIG. 1. In these and other embodiments, the method 400 may be performed based on the execution of instructions stored on one or more non-transitory computer-readable media. Although illustrated as discrete blocks, various blocks of the method 400 may be divided into additional blocks, combined into fewer blocks, or eliminated, depending on the desired implementation.

At block 410, initial inputs may be received, including initial search points with potential solutions and associated weights. The block 410 may be similar or comparable to the block 310 of FIG. 3. Additionally or alternatively, multiple evaluation functions may be identified as the multiple objectives in a multi-objective optimization problem.

At block 420, a scalarization and optimization may be applied to the initial search points to derive a secondary set of potential solutions. For example, a computing device may apply the scalarization to convert the multi-objective problem into a single-objective problem. The optimization may identify improvements in one or more of the evaluation functions by varying the values of the variables in the potential solutions.

At block 430, the secondary set of solutions may be subdivided by adding new solutions to the vertices of a simplex of the secondary set of solutions. For example, a computing device may generate a new potential solution at a midpoint of each vertex of the simplex of the secondary set of solutions.

At block 440, the scalarization and optimization may be performed on the subdivided secondary set of solutions. In these and other embodiments, the scalarization and optimization may be similar to that of the block 420, although performed on a larger set of potential solutions as the number of potential solutions has been subdivided.

At block 450, a weight adaptation may be performed on the weights of the set of solutions generated at the block 440. For example, the weights for the potential solutions may be varied to verify the improvement of the solutions, and to determine an improved weight applicable to a given variable as appropriate.

At block 460, the potential solutions of the previous iteration may be subdivided by adding new solutions to the vertices of the simplexes of the solutions of such potential solutions. The subdividing of the block 460 may be similar or comparable to the subdividing performed at the block 430, although multiple simplexes may be present to be subdivided.

At block 470, the scalarization, optimization, and subdivision may be repeated based on the previous iterations of potential solutions until a threshold has been reached. For example, the threshold may include a set number of iterations, a certain value in improvement, a small enough variation in values between iterations in seeking improvements, or any other threshold indicative of repeating the iterations a sufficient or desirable number of times.

One skilled in the art, after reviewing this disclosure, may recognize that modifications, additions, or omissions may be made to the method 400 without departing from the scope of the disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

One example of a mathematical implementation of the AWA-2 algorithm may be provided below. In particular, four algorithms are provided, the core AWA-2 algorithm as Algorithm 1, the search algorithm used in the AWA-2 algorithm as Algorithm 2, the subdivision algorithm used in the AWA-2 algorithm as Algorithm 3, and the weightAdaptation algorithm used in the search algorithm as Algorithm 4. The variables are those as used above.

Algorithm 1 AWA (f, P; s, o, φ, γ, ϵ, μ)

1: t ← 1
2: [symbol] ⁽¹⁾ ← search (P)
3: σ ← [p₀, ... , pₘ₋₁] (p₀, ... , pₘ₋₁ ϵ [symbol] ⁽¹⁾)
4: Σ⁽¹⁾ ← {σ}
5: while | [symbol] ^{(t)}| < μ do
6: Σ^{(t+1)} ← subdivision Σ^{(t)}
7: P ← search (Σ^{(t)})
8: [symbol] ^{(t+1)} ← [symbol] ^{(t)} ∪ P
9: t ← t + 1
10: end while
11: return [symbol] ^{(t)}

Algorithm 2 search (Σ; f, s, o, c, ϵ)

1: P ← Ø
2: for σ(= [p₀, ... , pₖ]) ϵ Σ do
3: if k ≥ 0 then
4: for i = 0 to k do
5: fᵢ ←[p₀, ... , pᵢ₋₁,pᵢ₊₁, ... , pₖ]
6: P′ ← search (fᵢ)
7: P ← P ∪ P′
8: end for
9: τ ← 0
10: loop
11: σ̅ old ← σ̅(= (x, w))
12: \hat{f} ← s(f, w)
13: x′ ← o(\hat{f}, x)
14: σ̅ ← (x′, w)
15: if [φ(σ̅), φ(σ̅_{old})| ≤ ϵ then
16: break
17: end if
18: w′ ← weightAdaptation (σ, τ)
19: σ̅ ← (x′, w′)
20: τ ← τ + 1
21: end loop
22: P ← P ∪ {p}
23: end if
24: end for
25: return P

Algorithm 3 subdivision (Σ)

1: Σ′ ← Ø
2: if Σ ≠ {Ø} then
3: for σ ( = [p₀, ... , pₖ]) ϵ Σ do
4: F ← {[p₀, ... , pᵢ₋₁,pᵢ₊₁, ... , pₖ]} ^{k}ᵢ= 0
5: Σ′ ← subdivision (F)
6: for σ′(= [p′₀, ... , p′ₖ₋₁]) ϵ Σ′ do
7: σ′ ← [p′₀, ... , p′ₖ₋₁, σ̅]
8: end for
9: end for
10: end if
11: return Σ′

Algorithm 4 weightAdaptation (σ(= p₀, ... , pₖ] ), τ; o, φ, γ)

1: for i = 0 to k do
2: vᵢ ← |[φ(p₀), ... , φ(pᵢ₋₁), φ(pᵢ₊₁), ... , φ(pₖ), φ(σ̅)]|
3: end for
4: j ← argmaxᵢ vᵢ
5: W ← (w₀ − w, ... , wⱼ₋₁ − w, wⱼ₊₁ − w, ... , wₖ − w)
6: u ← o(g, 0)
7: ŵ ← w + γ^{τ}Wu
8: return ŵ

FIG. 5 illustrates an example computing system 500 for improving evaluation functions for machine learning systems, according to at least one embodiment described in the present disclosure. Additionally or alternatively, the computing system 500 may be a computing system implementing a machine learning system that has its operation improved by embodiments of the present disclosure. The computing system 500 may include a processor 510, a memory 520, a data storage 530, and/or a communication unit 540, which all may be communicatively coupled. Any or all of the process 100 of FIG. 1 may be implemented by a computing system consistent with the computing system 500. In these and other embodiments, the computing system 500 may be a specialized computing system configured to perform specific and non-conventional operations, such as those identified in FIGS. 3 and 4.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of network or physical locations that are configured to perform individually or collectively any number of operations described in the present disclosure. In some embodiments, the processor 510 may interpret and/or execute program instructions and/or process data stored in the memory 520, the data storage 530, or the memory 520 and the data storage 530. In some embodiments, the processor 510 may fetch program instructions from the data storage 530 and load the program instructions into the memory 520.

After the program instructions are loaded into the memory 520, the processor 510 may execute the program instructions, such as instructions to perform the method 300 of FIG. 3 and/or the method 400 of FIG. 4. For example, the processor 510 may obtain instructions regarding determining causality in results of a machine learning system, and generating an explanation regarding the causality. As another example, the processor 510 may analyze user changes to assumptions leading to the explanation, and determine accuracy of a machine learning system based on those changes to assumptions.

The memory 520 and the data storage 530 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 510. In some embodiments, the computing system 500 may or may not include either of the memory 520 and the data storage 530.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 540 may include any component, device, system, or combination thereof that is configured to transmit or receive information over a network. In some embodiments, the communication unit 540 may communicate with other devices at other locations, the same location, or even other components within the same system. For example, the communication unit 540 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 540 may permit data to be exchanged with a network and/or any other devices or systems described in the present disclosure. For example, the communication unit 540 may allow the system 500 to communicate with other systems, such as computing devices and/or other networks.

One skill in the art, after reviewing this disclosure, may recognize that modifications, additions, or omissions may be made to the system 500 without departing from the scope of the present disclosure. For example, the system 500 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method, comprising:
identifying a plurality of evaluation functions related to operation of a machine learning system as a first set of inputs for a computing process configured to generate a Pareto set of solutions of the evaluation functions, the evaluation functions including at least two of generalization performance of the machine learning system, computing resource utilization of the machine learning system, or model interpretability;
identifying a set of initial search points for the computing process, each of the search points including a potential solution of the evaluation functions, each of the potential solutions including values for a set of variables affecting the evaluation functions and an associated weight for each of the variables; and
performing the computing process using both the plurality of evaluation functions and the set of initial search points such that the computing process varies the potential solutions over a potential solution space, thereby identifying the Pareto set of solutions that improve or hold steady a performance score of each of the evaluation functions.

2. The method of claim 1, further comprising outputting a graphical visualization of the potential solution space explored by the computing process.

3. The method of claim 1, wherein the computing process varies the associated weights of the potential solutions in a potential weight space, the method further comprising outputting a graphical or textual visualization of the potential weight space.

4. The method of claim 1, further comprising outputting a graphical or textual visualization of the performance scores of the evaluation functions.

5. The method of claim 1, wherein the potential solution space includes varying values for all of the variables.

6. The method of claim 1, further comprising outputting a recommendation for future improvements based on the Pareto set of solutions.

7. The method of claim 1, further comprising modifying operation of a computing system based on the Pareto set of solutions to improve operation of the computing system.

8. A non-transitory computer-readable medium containing instructions which, in response to being executed by one or more processors, cause a system to perform operations, the operations comprising:
identifying a plurality of evaluation functions related to operation of a machine learning system as a first set of inputs for a computing process configured to generate a Pareto set of solutions of the evaluation functions, the evaluation functions including at least two of generalization performance of the machine learning system, computing resource utilization of the machine learning system, or model interpretability;
identifying a set of initial search points for the computing process, each of the search points including a potential solution of the evaluation functions, each of the potential solutions including values for a set of variables affecting the evaluation functions and an associated weight for each of the variables; and
performing the computing process using both the plurality of evaluation functions and the set of initial search points such that the computing process varies the potential solutions over a potential solution space, thereby identifying the Pareto set of solutions that improve or hold steady a performance score of each of the evaluation functions.

9. The non-transitory computer-readable medium of claim 8, the operations further comprising outputting a graphical or textual visualization of the potential solution space explored by the computing process.

10. The non-transitory computer-readable medium of claim 8, wherein
the computing process varies the associated weights of the potential solutions in a potential weight space; and
the operations further comprise outputting a graphical or textual visualization of the potential weight space.

11. The non-transitory computer-readable medium of claim 8, the operations further comprising outputting a graphical or textual visualization of the performance scores of the evaluation functions.

12. The non-transitory computer-readable medium of claim 8, wherein the potential solution space includes varying values for all of the variables.

13. The non-transitory computer-readable medium of claim 8, the operations further comprising outputting a recommendation for future improvements based on the Pareto set of solutions.

14. The non-transitory computer-readable medium of claim 8, the operations further comprising modifying operation of a computing system based on the Pareto set of solutions to improve operation of the computing system.

15. A system comprising:
one or more processors;
one or more non-transitory computer-readable media containing instructions which, when executed by the one or more processors, causes the system to perform operations, the operations comprising:
identifying a plurality of evaluation functions related to operation of a machine learning system as a first set of inputs for a computing process configured to generate a Pareto set of solutions of the evaluation functions, the evaluation functions including at least two of generalization performance of the machine learning system, computing resource utilization of the machine learning system, or model interpretability;
identifying a set of initial search points for the computing process, each of the search points including a potential solution of the evaluation functions, each of the potential solutions including values for a set of variables affecting the evaluation functions and an associated weight for each of the variables; and
performing the computing process using both the plurality of evaluation functions and the set of initial search points such that the computing process varies the potential solutions over a potential solution space, thereby identifying the Pareto set of solutions that improve or hold steady a performance score of each of the evaluation functions.

16. The system of claim 15, the operations further comprising outputting a graphical visualization of the potential solution space explored by the computing process.

17. The system of claim 15, wherein
the computing process varies the associated weights of the potential solutions in a potential weight space; and
the operations further comprise outputting a graphical or textual visualization of the potential weight space.

18. The system of claim 15, the operations further comprising outputting a graphical or textual visualization of the performance scores of the evaluation functions.

19. The system of claim 15, the operations further comprising outputting a recommendation for future improvements based on the Pareto set of solutions.

20. The system of claim 15, the operations further comprising modifying operation of a computing system based on the Pareto set of solutions to improve operation of the computing system.
